(19) United States
(12) Patent Application Publication
(10) Pub. No.: US 2010/0033438 A1
(43) Pub. Date: Feb. 11, 2010

(54) TOUCH-BASED REMOTE CONTROL APPARATUS AND METHOD

(75) Inventors: SAMUEL FU, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/417,666

(22) Filed: Apr. 3, 2009

(30) Foreign Application Priority Data
Aug. 6, 2008 (CN) 200810303554.3

(51) Int. Cl. G06F 3/041; G05B 19/02

(52) U.S. Cl. 345/173; 340/825.22

(57) ABSTRACT

A touch-based remote control apparatus includes a touch pad, a processor and a transmitter. The touch pad is connected with a plurality of touch sensitive units, each of the touch sensitive units corresponding to a touch sensitive point of the touch pad and generates a sensing signal when a touch sensitive point on the touch pad is touched. The processor executes a main control program to identify a touch sensitive point according to the sensing signal, displays a graphical operation interface on the touch pad if the touch sensitive point corresponds to a mode selection icon, and executes a device control program to generate a control command according to the sensing signal if the touch sensitive point corresponds to a device control icon. The transmitter transforms the control command to a control signal, and transmits the control signal to remotely control a target electronic device.

### BACKGROUND

1. Technical Field

Embodiments of the present disclosure relate to remote control apparatuses and methods, and more particularly to a touch-based remote control apparatus and method having multi-functions.

2. Related Art

Generally, remote control apparatuses are popularly used to input commands for controlling electronic devices to perform corresponding functions. A conventional remote control apparatus includes a frame to support a plurality of mechanical function buttons that actuate predetermined functions. The more functions the remote control apparatus has, the more mechanical function buttons are disposed on the frame. Therefore, the frame should be designed as large as possible to hold the mechanical function buttons. As a result, a volume of the remote control apparatus as a whole becomes larger, and an overall appearance of the whole remote control apparatus looks bulky.

Furthermore, the instructions corresponding to the buttons are stored in the internal memory of the remote control apparatus. However, the instructions are fixed in the memory of the remote control apparatus, so the instructions cannot timely be updated in the internal memory according to user's requirements. This problem may result in limiting the number of electronic devices that can be controlled by the remote control apparatus.

Therefore, there is a touch-based remote control apparatus and method having multi-functions which can overcome the above-mentioned problems.

### BRIEF DESCRIPTION OF THE DRAWINGS

FIG. 1 is a schematic diagram of one embodiment of a touch-based remote control apparatus.

FIG. 2 is a schematic diagram of one embodiment of a main control program stored in a storage device.

FIG. 3 is a flowchart of one embodiment of a touch-based remote control method by the touch-based remote control apparatus of FIG. 1.

### DETAILED DESCRIPTION

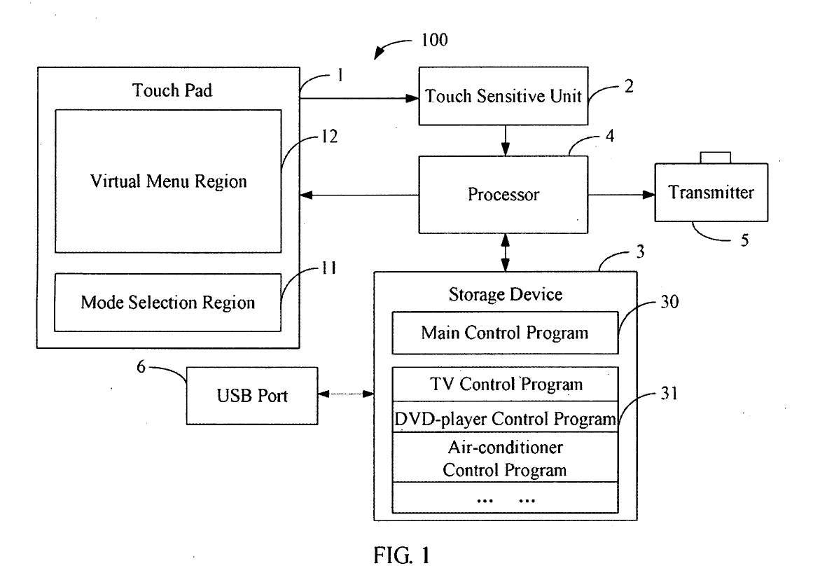

FIG. 1 is a schematic diagram of one embodiment of a touch-based remote control apparatus 100. In one embodiment, the touch-based remote control apparatus 100 may comprise a touch pad 1, a plurality of touch sensitive units 2 (only one shown in FIG. 1), a storage device 3, a processor 4, a transmitter 5, and a universal serial bus (USB) port 6. The touch pad 1 is connected to the plurality of touch sensitive units 2 and the processor 4, and each of the touch sensitive units 2 is connected to the processor 4. The processor 4 is further connected to the storage device 3 and the transmitter 5. The storage device 3 is connected with the USB port 6, which is used to connect an external device such as a hard disk, a storage card, or a data storage medium.

In one embodiment, the touch pad 1 comprises a mode selection region 11 and a virtual menu region 12, each of which includes a plurality of touch sensitive points. Each of the sensitive points corresponds to a touch sensitive unit 2, which is included in a sensitive matrix. Each of the touch sensitive units 2 corresponds to a matrix-vector value that indicates a position of the touch sensitive unit 2 in the sensitive matrix. The touch sensitive unit 2 generates a sensing signal when one of the touch sensitive point on the touch pad 1 is touched.

The storage device 3 is logically divided into a first storage area and a second storage area. The first storage area is used to store a main control program 30, and the second storage area is used to store a plurality of device control programs 31 such as a television (TV) control program, a digital video disk (DVD)-player control program, an air-conditioner control program, and etc. The main control program 30 is configured for calling one of the device control programs 31 from the second storage area according to the sensing signal. When a user want to control an electronic device that needs a new device control program, the user can upload the new device control program to the second storage area of the storage device 3 via the USB port 6. Thereby the remote control apparatus 100 can be configured to remotely control numerous type of electronic devices to perform multi-functions. In one example, the storage device 3 may be a flash-based memory system.

The mode selection region 11 is used to provide a navigation interface that includes a plurality of mode selection icons for selecting target electronic devices to be controlled. When one of the target electronic devices needs to be controlled, a mode selection icon corresponding to the target electronic device is selected on the mode selection region 11. The mode selection icons may be a TV mode selection icon, a DVD-player mode selection icon, and an air-conditioner mode selection icon, or any other electronic device mode selection icon. Each of the mode selection icons corresponds to one of the device control programs 31 that is stored in the second area of the storage device 3. For example, the TV mode selection icon corresponds to the TV control program, the DVD-player mode selection icon corresponds to the DVD-player control program, and the air-conditioner mode selection icon corresponds to the air-conditioner control program.

The virtual menu region 12 is used to provide a graphical operation interface for the user to control the electronic device to perform corresponding functions when a device control program 31 is called by the main control program 30. The graphical operation interface may be a TV operation interface, a DVD-player operation interface, and an air-conditioner operation interface, and any other electronic device operation interface. The graphical operation interface includes a plurality of device control icons that are used to control the target electronic device to perform functions correspondingly. For example, the TV operation interface includes a plurality of TV control icons, the DVD-player operation interface includes a plurality of DVD-player control icons, and the air-conditioner operation interface includes a plurality of air-conditioner control icons. The virtual menu region 12 displays the graphical operation interface when a mode selection icon of the mode selection region 11 is touched. For example, the virtual menu region 12 displays the TV operation interface when the TV mode selection icon of the mode selection region 11 is touched. Thereby, the user can remotely control a TV set to perform kinds of functions by touching the TV control icons of the TV operation interface displayed on the virtual menu region 12.

In one embodiment, each of the mode selection icons and the device control icons may be a logo, one or more characters, or a combination of the logo and the one or more characters.

The processor 4 is configured for executing the main control program 30 to analyze the sensing signal generated by the touch sensitive unit 2 when one of the touch sensitive points of the touch pad 1 is touched. The processor 4 is further configured for identifying the touch sensitive point according to the matrix-vector value corresponding to the sensing signal. The processor 4 executes the main control program 30 to call one of the device control programs 31 corresponding to the mode selection icon and displays the graphical operation interface if the touch sensitive point corresponds to a mode selection icon. In addition, the processor 4 executes the device control program 31 to generate a control command if the touch sensitive point corresponds to a device control icon, and transmits the control command to the transmitter 5.

The transmitter 5 is configured for receiving the control command from the processor 4, transforming the control command to a control signal, and transmitting the control signal to the target electronic device, so as to control the target device to perform the functions corresponding to the control command. The transmitter 5 transmits the control signal to the electronic device by an infrared ray technique, a radio frequency technique, or a Bluetooth technique.

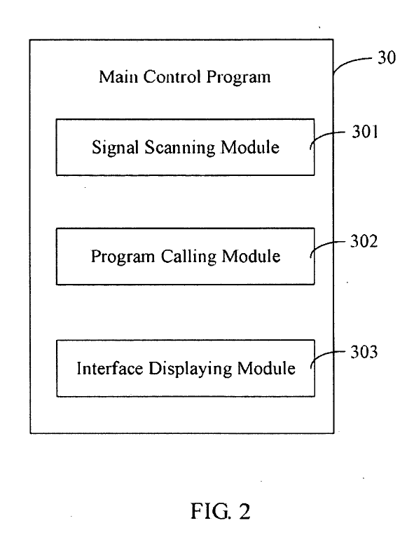

FIG. 2 is a schematic diagram of one embodiment of the main control program 30 stored in the storage device 3. In one embodiment, the main control program 30 may be a software program including a plurality of instructions, and installed in the first storage area of the storage device 3. The main control program 30 includes a signal scanning module 301, a program calling module 302, and a interface displaying module 303.

The signal scanning module 301 is configured for scanning the sensing signal generated by one of the touch sensitive units 2 when a touch sensitive point of the touch pad 1 is touched, confirming a matrix-vector value of the touch sensitive unit 2 in the sensitive matrix, and identifying whether the touch sensitive point corresponds to a mode selection icon or a device control icon according to the matrix-vector value. The program calling module 302 is configured for calling one of the control programs 31 (e.g. a TV control program) from the second storage area of the storage device 3 if the touch sensitive point corresponds to the mode selection icon. The interface displaying module 303 is configured for displaying a graphical operation interface (e.g. a TV operation interface) in the virtual menu region 12 of the touch pad 1 when the device control program 31 (e.g. the TV control program) is executed by the processor 4.

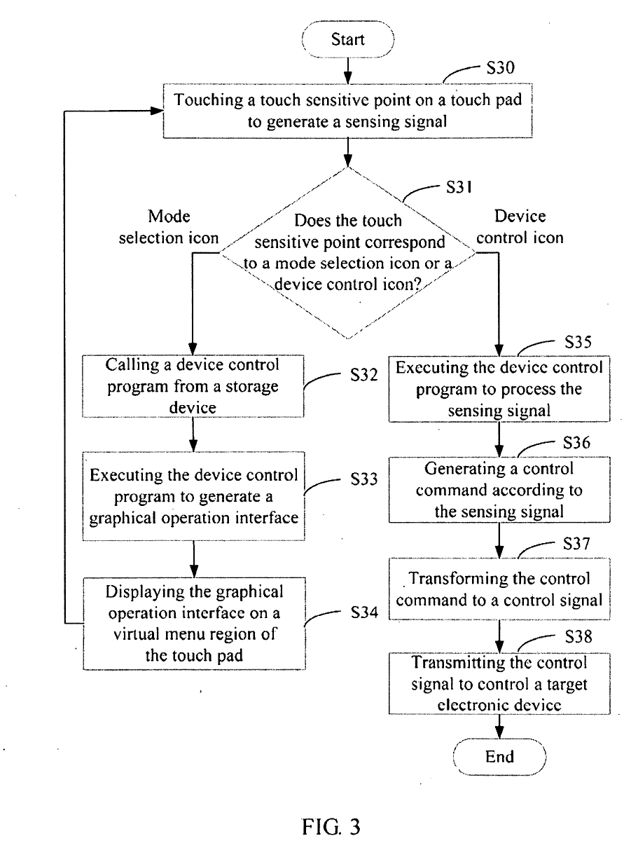

FIG. 3 is a flowchart of one embodiment of a touch-based remote control method by the apparatus 100 of FIG. 1 as described above. Depending on the embodiment, additional blocks may be added, others removed, and the ordering of the blocks may be changed.

In block S30, the touch sensitive unit 2 generates a sensing signal when a touch sensitive point of the touch pad 1 is touched, and transmits the sensing signal to the processor 4. When the processor 4 receives the sensing signal from the touch sensitive unit 2, the processor 4 reads a main program 30 from the first storage area of the storage device 3, and initializes the signal scanning module 301, the program calling module 302 and the interface displaying module 303 of the main program 30 to process the sensing signal.

In block S31, the signal scanning module 301 scans the sensing signal generated from the touch sensitive unit 2, and identifies the touch sensitive point according to the sensing signal by confirming a matrix-vector value of the touch sensitive unit 2 in the sensitive matrix. Namely, the signal scanning module 301 determines whether the touch sensitive point corresponds to a mode selection icon or a device control icon according to the matrix-vector value. The mode selection icon corresponds to a target electronic device that needs to be controlled remotely, and is displayed on the mode selection region 11 of the touch pad 1.

If the touch sensitive point corresponds to a mode selection icon, in block S32, the program calling module 302 calls one of the device control programs 31 (e.g. a TV control program) from the second storage area of the storage device 3. For example, if the target electronic device is an TV set, the program calling module 302 calls the TV control program from the second storage area of the storage device 3. If the touch sensitive point corresponds to a device control icon, the procedure goes to block S35 as described below.

In block S33, the processor 4 executes the device control program 31 to generate a graphical operation interface (e.g. a TV operation interface) to facilitate controlling the target electronic device to perform corresponding functions remotely. The graphical operation interface includes a plurality of device control icons selectable to remotely control the target electronic device. As mentioned above, the graphical operation interface may be a TV operation interface, a DVD-player operation interface, and an air-conditioner operation interface. For example, the TV operation interface includes a plurality of TV control icons, the DVD-player operation interface includes a plurality of DVD-player control icons, and the air-conditioner operation interface includes a plurality of air-conditioner control icons.

In block S34, the interface displaying module 303 displays the graphical operation interface (e.g. the TV operation interface) in virtual menu region 12 of the touch pad 1 when the device control program 31 (e.g. the TV control program) is executed by the processor 4, and the returns to block S30 as described above.

In block S35, the processor 4 executes the device control program 31 to process the sensing signal generated from the touch sensitive unit 2, if the touch sensitive point corresponds to a device control icon of the virtual menu region 12.

In block S36, the processor 4 executes the device control program 31 to generate a control command for controlling the target electronic device according to the sensing signal, and transmits the control command to the transmitter 5. For example, if volume of the TV set is desired to be increased and a TV volume icon is touched, as a result, the processor 4 executes the TV control program to generate a volume control command for controlling the TV set to increase the volume.

In block S37, the transmitter 5 receives the control command from the processor 4, and transforms the control command to a control signal. In block S38, the transmitter 5 transmits the control signal to remotely control the target electronic device to perform the corresponding functions. The transmitter 5 may transmit the control signal to the target electronic device by an infrared ray technique, a radio frequency technique, or a Bluetooth technique.

In the embodiment, if a new electronic device needs to be controlled, a new device control program can be loaded into the second storage area of the 3 via the USB port 6. Thereby the remote control apparatus 100 can be configured to remotely control numerous type of electronic devices to perform multi-functions.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A touch-based remote control apparatus, the apparatus comprising:
a touch pad being connected with a plurality of touch sensitive units, each of the touch sensitive units corresponding to a touch sensitive point of the touch pad, and capable of generating a sensing signal when a user touches the touch sensitive point on the touch pad;
a storage device being logically divided into a first storage area and a second storage area, wherein the first storage area stores a main control program and the second storage area stores one or more device control programs;
a processor configured for executing the main control program to identify the touch sensitive point according to the sensing signal, and executing the main control program to call a device control program from the one or more device control programs, and displaying a graphical operation interface if the touch sensitive point corresponds to a mode selection icon, or executing the device control program to generate a control command according to the sensing signal if the touch sensitive point corresponds to a device control icon; and
a transmitter configured for receiving the control command, transforming the control command to a control signal, and transmitting the control signal to remotely control an electronic device.

2. The apparatus according to claim 1, further comprising a universal serial bus (USB) port configured for uploading the one or more device control programs to the second storage area of the storage device.

3. The apparatus according to claim 1, wherein the touch sensitive units are included in a sensitive matrix and each of the touch sensitive units corresponds to a matrix-vector value that indicates a position of the touch sensitive unit in the sensitive matrix.

4. The apparatus according to claim 3, wherein the main program comprises:
a signal scanning module configured for scanning the sensing signal, confirming each matrix-vector value of the touch sensitive units in the sensitive matrix, and identifying the touch sensitive point according to a matrix-vector value corresponding to the sensing signal.

5. The apparatus according to claim 1, wherein the touch pad comprises a mode selection region that provides a navigation interface comprising a plurality of mode selection icons corresponding to electronic devices to be controlled, and a virtual menu region that provides the graphical operation interface comprising a plurality of device control icons for controlling the electronic devices to perform corresponding functions.

6. The apparatus according to claim 5, wherein the main program comprises:
a program calling module configured for calling one of the one or more device control programs from the second storage area according to the mode selection icon touched by the user; and
an interface displaying module configured for displaying the graphical operation interface on the virtual menu region of the touch pad when the device control program is executed.

7. The apparatus according to claim 5, wherein each of the mode selection icons and the device control icons is selected from the group consisting of a logo, one or more characters, and a combination of the logo and the one or more characters.

8. The apparatus according to claim 1, wherein the transmitter transmits the control signal to the target electronic device by an infrared ray technique, a radio frequency technique, or a Bluetooth technique.

9. A touch-based remote control method, the method comprising:
generating a sensing signal when a touch sensitive point of a touch pad of a remote control apparatus is touched;
determining whether the touch sensitive point corresponds to a mode selection icon or a device control icon according to the sensing signal;
calling a device control program from a storage device of the remote control apparatus, and executing the device control program to display a graphical operation interface on the touch pad, if the touch sensitive point corresponds to a mode selection icon; or
executing the device control program to process the sensing signal, if the touch sensitive point corresponds to a device control icon;
generating a control command according to the sensing signal, and transmitting the control command to a transmitter of the remote control apparatus; and
transforming the control command to a control signal, and transmitting the control signal to remotely control an electronic device.

10. The method according to claim 9, wherein the main control program is stored in a first storage area of the storage device, and the device control program is stored in a second storage area of the storage device.

11. The method according to claim 10, further comprising:
uploading the device control program to the second storage area of the storage device via a universal serial bus (USB) port.

12. The method according to claim 9, wherein the touch pad is connected with a plurality of touch sensitive units, and each of the touch sensitive units corresponds to a touch sensitive point on the touch pad.

13. The method according to claim 12, wherein the touch sensitive units are included in a sensitive matrix and each of the touch sensitive units corresponds to a matrix-vector value that indicates a position of the touch sensitive unit in the sensitive matrix.

14. The method according to claim 13, further comprising:
scanning the sensing signal generated by a touch sensitive unit corresponding to the touch sensitive point;
confirming the matrix-vector value of the touch sensitive unit in the sensitive matrix; and
identifying the touch sensitive point according to the matrix-vector value.

15. The method according to claim 9, wherein the mode selection icon is displayed on a mode selection region of the touch pad and corresponds to the device control program, and the device control icon is displayed on a virtual menu region of the touch pad and controls the electronic device to perform corresponding functions.

16. A medium having stored thereon instructions that, when executed by a processor of a touch-based remote control apparatus, causes the processor to perform a method for remotely controlling electronic devices, the method comprising:
generating a sensing signal when a touch sensitive point of a touch pad of the remote control apparatus is touched;
determining whether the touch sensitive point corresponds to a mode selection icon or a device control icon according to the sensing signal;
calling a device control program from a storage device of the remote control apparatus and executing the device control program to display a graphical operation interface on the touch pad, if the touch sensitive point corresponds to the mode selection icon; or
executing the device control program to process the sensing signal, if the touch sensitive point corresponds to the device control icon;
generating a control command according to the sensing signal, and transmitting the control command to a transmitter of the remote control apparatus; and
transforming the control command to a control signal, and transmitting the control signal to remotely control a corresponding electronic device.

17. The medium according to claim 16, wherein the method further comprises:
uploading the device control program to the storage device via a universal serial bus (USB) port.

18. The medium according to claim 16, wherein the touch pad is connected with a plurality of touch sensitive units, and each of the touch sensitive units corresponds to a touch sensitive point of the touch pad.

19. The medium according to claim 18, wherein the touch sensitive units are included in a sensitive matrix and each of the touch sensitive units corresponds to a matrix-vector value that indicates a position of the touch sensitive unit in the sensitive matrix.

20. The medium according to claim 19, wherein the method further comprises:
scanning the sensing signal generated by a touch sensitive unit corresponding to the touch sensitive point;
confirming the matrix-vector value of the touch sensitive unit in the sensitive matrix; and
identifying the touch sensitive point according to the matrix-vector value.
